(19) United States
(12) Patent Application Publication
(10) Pub. No.: US 2012/0144551 A1
(43) Pub. Date: Jun. 14, 2012

(54) Conductive Garment

(76) Inventor: Eric Guldalian, Abington, PA (US)

(21) Appl. No.: 13/315,940

(22) Filed: Dec. 9, 2011

Related U.S. Application Data
(60) Provisional application No. 61/421,359, filed on Dec. 9, 2010.

(51) Int. Cl. A41D 13/00; B23P 19/04; A41D 1/04

(52) U.S. Cl. 2/102; 2/69; 29/428

(57) ABSTRACT

A conductive garment that has electrodes that can be used for medical applications, such as electrotherapy or electrocardiography. The garment includes a first front panel, a second front panel detachably connected to the first front panel by an interconnecting device, a back panel, a first lateral panel and a second lateral panel, each lateral panel including a first end and second end. The first lateral panel and the second lateral panel are placed on opposite sides of the back panel; and the first end of each lateral panel is detachably connected to the back panel and wherein the second end of the first lateral panel is detachably connected to the first front panel and the second end of the second lateral panel is detachably connected to the second front panel.

### CROSS REFERENCE TO RELATED APPLICATIONS

This application claims benefit to provisional application 61/421,359, filed on Dec. 9, 2010, entitled, “Conductive Garment”, which is incorporated by reference herein in its entirety for all purposes.

### BACKGROUND OF THE INVENTION

The present invention relates to electrical sensors used in treatment and monitoring of human bodies, and more particularly to a conductive garment that provides direct and easy access for such sensors to contact the skin.

It is well known in the art to use electrodes for medical applications, such as electrotherapy or electrocardiography. The electrodes are required to contact the surface skin of the patient. The current state of the art requires garments worn by the subject to be removed, rolled up, or otherwise adjusted to accommodate the electrodes if the muscles or tissues of interest are covered by the garment. In addition, the prior art garments cannot be easily adapted to the patient size.

As can be seen, there is a need for a garment designed to hold electrodes that can be easily and effectively adjusted, depending on the patient size.

### SUMMARY OF THE INVENTION

It is an aspect of the invention to provide an improved garment which can be used for medical purposes.

The above aspects can be obtained by a garment that includes (a) a first front panel; (b) a second front panel detachably connected to the first front panel by an interconnecting device; (c) a back panel; (d) a first lateral panel and a second lateral panel, each lateral panel including a first end and second end; (e) wherein the first lateral panel and the second lateral panel are placed on opposite sides of the back panel; and (f) wherein the first end of each lateral panel is detachably connected to the back panel and wherein the second end of the first lateral panel is detachably connected to the first front panel and the second end of the second lateral panel is detachably connected to the second front panel.

These and other features, aspects and advantages of the present invention will become better understood with reference to the following drawings, description and claims.

### BRIEF DESCRIPTION OF THE DRAWINGS

FIG. 1 illustrates a perspective front view of a conductive garment according to an exemplary embodiment of the present invention;

FIG. 2 illustrates a perspective rear view of the conductive garment according to FIG. 1;

FIG. 3 illustrates a front view of a front panel and lateral panels of the conductive garment of FIG. 1;

FIG. 4 illustrates a rear view of the front panel of FIG. 3;

FIG. 5 illustrates a detailed view of the lateral panels of FIG. 3;

FIG. 6 illustrates a front view of the lateral panels of FIG. 5 according to an exemplary embodiment of the present invention showing an extension panel attached to the lateral panel;

FIG. 7 illustrates a front view of the back panel according to FIG. 1;

FIG. 8 illustrates a rear view of the back panel of FIG. 7;

FIG. 9 illustrates a perspective front view of the back panel according to an alternative embodiment of the present invention;

FIG. 10 illustrates a rear view of a removable electrode panel with accessory compartment according to an exemplary embodiment of the present invention;

FIG. 11 illustrates a front view of the belt according to FIG. 9;

FIG. 12 illustrates a rear view of the belt according to FIG. 11;

FIG. 13 illustrates a perspective front view of the back panel according to another exemplary embodiment of the present invention showing the back panel with a compartment;

FIG. 14 illustrates a front view of a removable electrode panel with embedded electrode circuits according to an exemplary embodiment of the present invention;

FIG. 15 illustrates a rear view of a removable electrode panel with embedded electrode circuits and accessory compartment according to FIG. 14;

FIG. 16 illustrates a perspective front view of a conductive garment according to another exemplary embodiment of the present invention with semi-detachable shoulder straps;

FIG. 17 illustrates a perspective front view of a conductive garment showing a disengaged shoulder strap according to FIG. 16; and

FIG. 18 illustrates a perspective front view of a conductive garment according to another exemplary embodiment of the present invention showing shoulder straps shaped differently than those in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Broadly, an embodiment of the present invention generally provides a conductive garment having multiple panels that are not permanently affixed to each other thereby allowing a patient to conveniently adjust the length and circumference of the garment.

The conductive garment according to the present invention may be worn around the torso of a patient so electrodes may contact the skin of the patient. In one embodiment, the conductive garment may be a vest. In order to maintain safe and proper conductivity, the conductive garment may be fitted tight against the body of the patient to eliminate interstitial spaces between the electrodes and the skin of the patient.

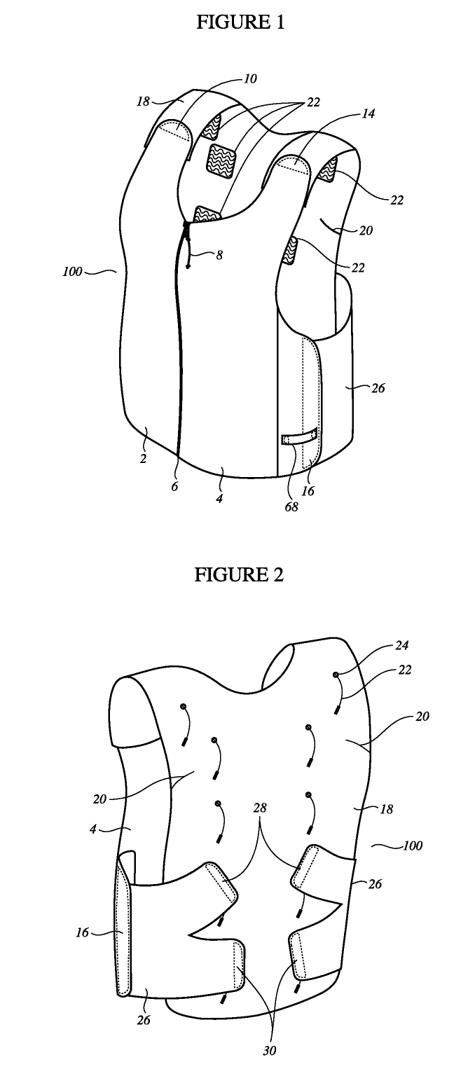

FIG. 1 illustrates a perspective front view of a conductive garment according to an exemplary embodiment of the present invention. FIG. 2 illustrates a perspective rear view of the conductive garment according to FIG. 1.

The conductive garment may include a first front panel 2, a second front panel 4 connected to the first front panel 2 by interconnecting devices 6 and 8, a back panel 18, and lateral panels 26 connecting the front panels 2 and 4 with the back panel 18.

The first front panel 2 and the second front panel 4 may be made of an elastic material, a non-elastic material, or combination thereof. The material of the front panel 2 may expand and contract around the abdominal and chest areas of the patient when stretched. The first front panel 2 and the second front panel 4 may be connected by interconnecting devices 6 and 8. The interconnecting devices 6 and 8 may be a zipper and pull tab, hook and loop fasteners, adhesive strips, clips, buttons, snaps, or clasps. In one embodiment, the interconnecting devices 6 and 8 may be a zipper made of metal or plastic and a pull tab. In addition, a loop 68 may be attached to the first front panel 2 and/or the second front panel 4 to attach a device(s), such as an electrical stimulator.

In FIG. 1, connecting point 14 attaches to back panel 18 using VELCRO brand hook fastener, or other connector types, on an opposite side from the front visible portion of the front panel 4. The broken line semicircle depicts that the hook fastener is present on the opposite side of the front panel 4 (hidden from the current view).

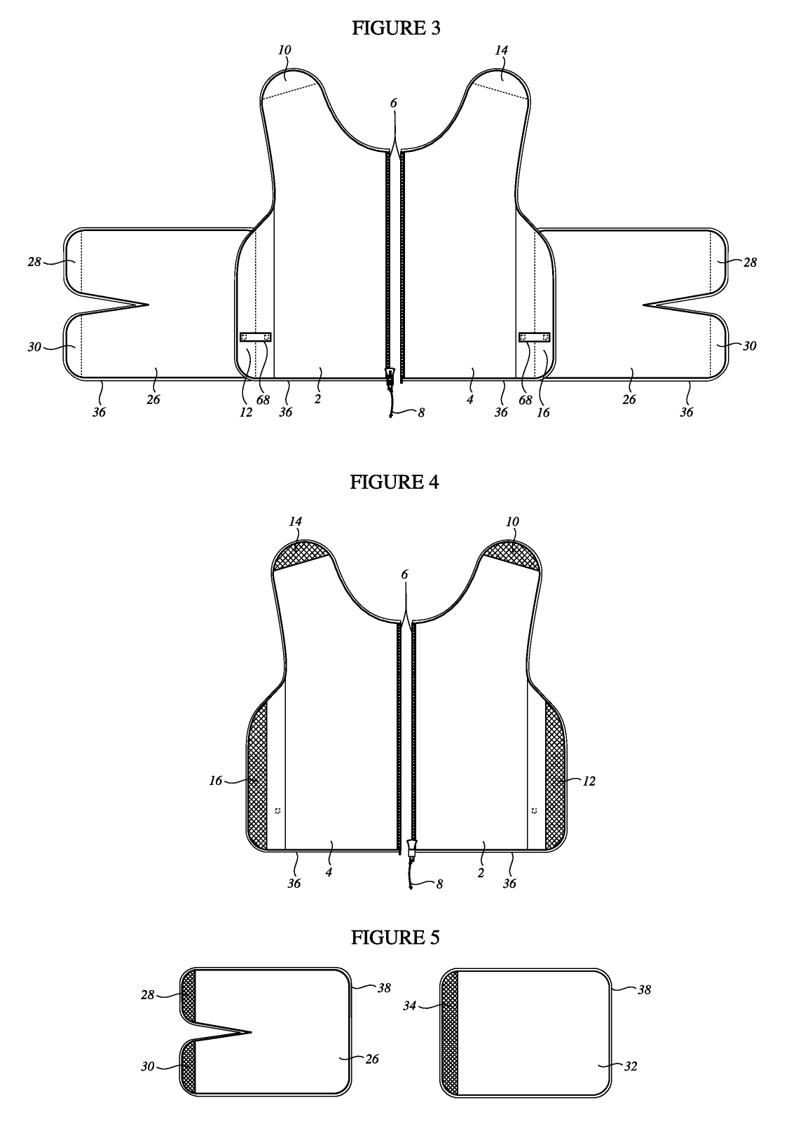

FIG. 3 illustrates a front view of a front panel and lateral panels of the conductive garment of FIG. 1. FIG. 4 illustrates a rear view of the front panel of FIG. 3.

The first front panel 2 may include a first connecting point 10 at its top end and a second connecting point 12 on its side. The second front panel 4 may include a first connecting point 14 at its top end and a second connecting point 16 on its side. The connecting points 10, 12, 14, and 16 may allow the patient to adjust the length and circumference of the conductive garment around the lumbar, thoracic, and cervical regions of the back for a snug fit against the skin. In one embodiment, the connecting points 10, 12, 14, and 16 may be a hook type material.

The back panel 18 may be made of a non-elastic material. In one embodiment the back panel 18 may be made of a non-elastic fabric that may allow the interconnection with the connecting points 10, 12, 14, and 16 of the front panels 2 and 4. In one embodiment, the back panel 18 may be made of a loop type material.

Apparel darts 20 may be included on the back panel 18. The apparel darts 20 (the line 20 is a seam) may be a seam that joins two sides of fabric cut to form an angle. The apparel darts help the garment to be more form fitting. Without the apparel darts, the garment may not make as good contact with the patient's skin. In order to make a dart, some of the material is cut out, and opposing edges are pulled together and stitched to make a seam.

An elastic trim 36 may be attached to the perimeter of the front panels 2 and 4 to provide an aesthetic finish to the conductive garment. In addition, an elastic trim 36 may stretch in tandem with the elastic material used to make the first front panel 2 and the second front panel 4. The elastic trim 36 may be made of an elastic material. In one embodiment, the elastic trim 36 may be made of Lycra®. Alternatively, the elastic trim 36 may be made of Lycra® blended with other natural and/or synthetic fibers.

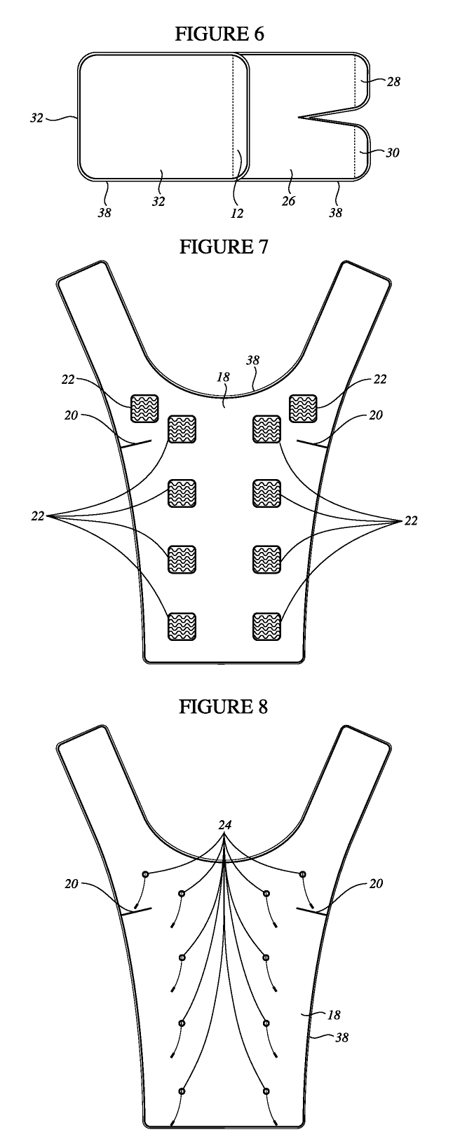

FIG. 5 illustrates a detailed view of the lateral panels of FIG. 3. FIG. 6 illustrates a front view of the lateral panels of FIG. 5 according to an exemplary embodiment of the present invention showing an extension panel attached to the lateral panel.

The front panels 2 and 4 may include lateral panels (which are a separate piece) 26 on one of its ends. The lateral panels 26 may be used to connect the first front panel 2 and the second front panel 4 to the back panel 18. In one embodiment, the lateral panels 26 may include a bifurcated end. Having the bifurcated ends may allow the lateral panels 26 to pull and hold the conductive garment tight against the body from varying degrees and tension levels. In one embodiment, the lateral panel 26 may be divided into two or more branches of equal or varying length to provide greater control and adjustment while manipulating the fabric.

The lateral panels 26 may include connecting points 28 and 30 on the interior side of their free ends. Connecting points 28 and 30 may interconnect with the fabric of the back panel 18. In one embodiment, the connecting points 28 and 30 may be made of a hook type fastener, such as VELCRO. Optionally, at least one extension panel 32 may be connected to the lateral panel 26 to extend the circumference of the conductive garment. The extension panel 32 may include a connecting point 34 to allow the connection with the lateral panel 26. In one embodiment, the connection point 34 may be the matching part of the connecting points 28 and 30.

A non-elastic trim 38 may be attached to the perimeter of the lateral panels 26, the back panel 18, and the extension panel 32. The non-elastic trim 38 may be made of a non-elastic material. In one embodiment, the non-elastic trim 38 may be made of cotton, polyester, a cotton polyester blend, or other natural and/or synthetic fibers. In one embodiment, the elastic trim 36 and the non-elastic trim 38 may be replaced by an over-lock stitch or a cord edge sewn along the perimeter of the panels. In one embodiment, the back panel 18, lateral panels 26, and/or the extension panels 32 may include measuring marks to indicate the current circumference setting around the waist. In a similar manner, the front panels 2 and 4 and the back panel 18 may include measuring marks around connection devices 10 and 14 to indicate the current approximate length of the conductive garment.

FIG. 7 illustrates a front view of the back panel according to FIG. 1. FIG. 8 illustrates a rear view of the back panel of FIG. 7. The back panel 18 may include a plurality of removable electrodes 22 adapted to be used on medical applications. The electrodes 22 may be affixed to the interior side of the back panel 18. The rear side of the back panel 18 may include orifices 24 to allow the back panel 18 to feed through electrical wire(s) attached to the electrodes 22. The orifices 24 may be punched or cut in a symmetrical layout along the spine spanning from the lumbar to cervical regions of the conductive garment 100. In one embodiment, orifices 24 may be punched or cut in an asymmetrical layout along the spine spanning from the lumbar to cervical regions of the conductive garment 100.

The conductive garment according to the present invention includes a plurality of independent panels that detachably connect to each other to form the conductive garment. Each panel may be designed to attach and detach from each other using easy detachable connecting devices, thus eliminating permanently sewn seams. This ability to attach and detach the panels from each other may allow adjusting the length and circumference dimensions of the conductive garment to fit different shape and size patients.

Prior to wearing the conductive garment, the patient may connect the first front panel 2 and the second front panel 4 to the upper section of the back panel 18 forming apertures for passing the arms of the patient. Then, one side of one of the lateral panels 26 may be attached to the first front panel 2 and the other side to the back panel 18. One side of the other lateral panel 26 may be attached to the second front panel 4 and the other side to the back panel 18. Optionally, at least one extension panel 32 may be attached to the lateral panels 26 to increase the circumference of the garment around the waist and chest areas. Depending on the length of a patient, when the back panel 18 is attached to connection points 10 and 14 on the first front panel 2 and the second front panel 4 there may be a layering effect of residual material from the back panel 18 around the shoulder area. This residual material may be fastened to the first front panel 2 and the second front panel 4 using interconnecting devices, such as hook and loop fasteners, adhesive strips, clips, buttons, pins, snaps, or clasps. Depending on the circumference of a patient, when the lateral panels 26 or extension panels 32 are attached to connection points 12 and 16 on the first front panel 2 and the second front panel 4 there may be a layering effect of residual material from the lateral panel 26 or extension panel 32 around the abdominal area. This residual material may be fastened to the first front panel 2 and the second front panel 4 using interconnecting devices, such as hook and loop fasteners, adhesive strips, clips, buttons, pins, snaps, or clasps.

The electrodes 22 required for use during a medical treatment may be affixed to the interior side of the back panel 18 with all wiring fed through the corresponding orifices 24 prior to wearing the conductive garment. Electrodes 22 may include a hook fastener on their back side to facilitate attaching and detaching the electrode 22 to the interior side of the back panel 18 made of a fabric having loop properties. Alternatively, electrodes 22 may be made of a gel based material on their back side to facilitate attaching and detaching the electrode 22 to the interior side of the back panel 18 made of a fabric having loop properties.

The patient may open up the conductive garment by detaching the interconnecting device 6 and 8. This may expose the interior side of the conductive garment allowing the electrodes to be arranged according to the prescribed medical protocol. Next, the patient may place each arm through the corresponding arm aperture and pull up the conductive garment around the shoulders. The patient may connect the first and second panels by attaching the interconnecting devices 6 and 8. At this point, the conductive garment may be wrapped around the entire torso of the patient. The patient may adjust the conductive garment to fit around its torso by disengaging and engaging the lateral panels 26 and front panels 2 and 4 at the connections points 10, 12, 14, and 16.

To increase the circumference around the waist of the patient, an extension panel 32 may be attached to at least one of the lateral panels 26. The shoulder adjustment points can be manipulated to pull material in or push material out to decrease or increase the overall length of the conductive garment.

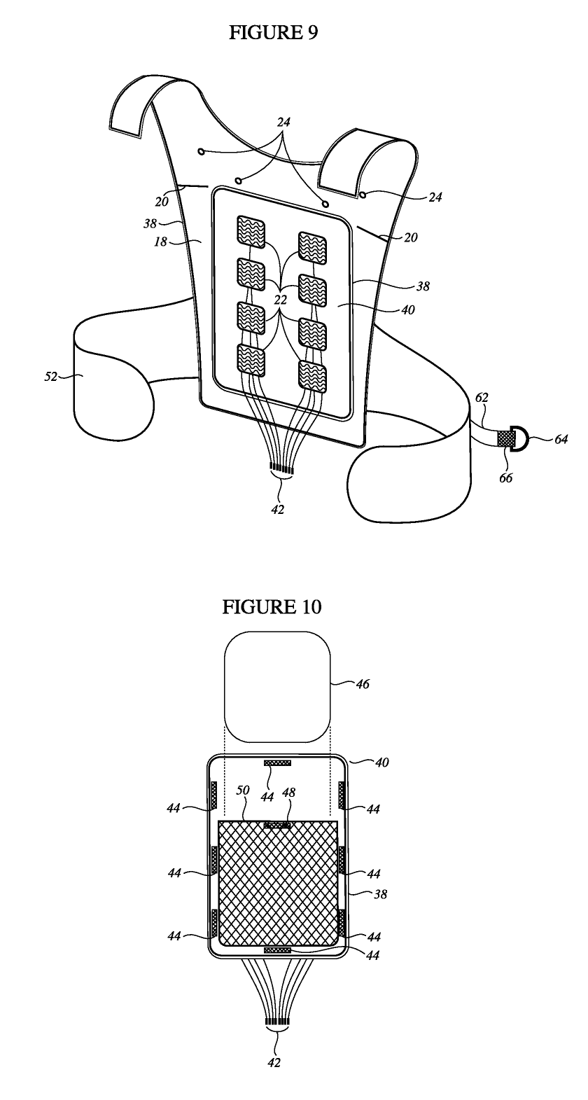

FIG. 9 illustrates one embodiment of the present invention in which a removable belt 52 may be affixed to the back panel 18. The removable belt 52 may be made of foam laminated with fabric that has loop properties enabling one end with a fastener 56 to affix to the opposite end. In addition, the conductive garment may include a removable electrode panel 40. The removable panel 40 may include removable electrodes 22 attached on one side and a compartment 50 on the opposite side. The compartment 50 may serve to store accessories, such as a rigid or semi-rigid insert 46, hot and/or cold packs. Lead wire 42 may be connected to the electrodes 22 on the removable electrode panel 40 and a jack or plug may be connected at one end to receive the electrode connections. At least one fastener 44 may be connected to the perimeter of the removable electrode panel 40 to attach the panel 40 to the back panel 18. In one embodiment, the fastener 44 may be a hook type fastener. The electrodes are not affixed directly onto 18 but instead onto removable panel 40, and on the backside (FIG. 10) of electronic panel 40. A rigid or semi-rigid insert 46 slides down into mesh compartment 50. The rigid or semi-rigid insert 46 can provide lumbar support if the patient needs it. One or both D-rings 64 can be grabbed and pulled forward until the patient has achieved an optimal level of compression and then the compression/position of the removable belt 52 is maintained by tightening the outer belting system 62 using a hook fastener 66, such as VELCRO brand hook, where it connects anywhere onto the outer side of the removable belt 52. The removable belt 52 has “loop” properties on the outside, wherein a hook fastener (e.g., VELCRO) would stick to anywhere on it.

FIG. 10 illustrates a rigid or semi-rigid insert 46 may be introduced into a compartment 50 on the rear side of a removable panel 40 to provide structural support to the panel 40. A fastener 48 may be used to close the compartment 50. The shape of the removable panel 40 may be rectilinear, curvilinear, or a combination thereof. The removable panel 40 may be made in different sizes by varying the overall length and width. Two or more separate compartments 50 may be included on the rear side of a single removable panel 40 to store a plurality of accessories, such as rigid or semi-rigid inserts 46, hot/cold packs, and the like.

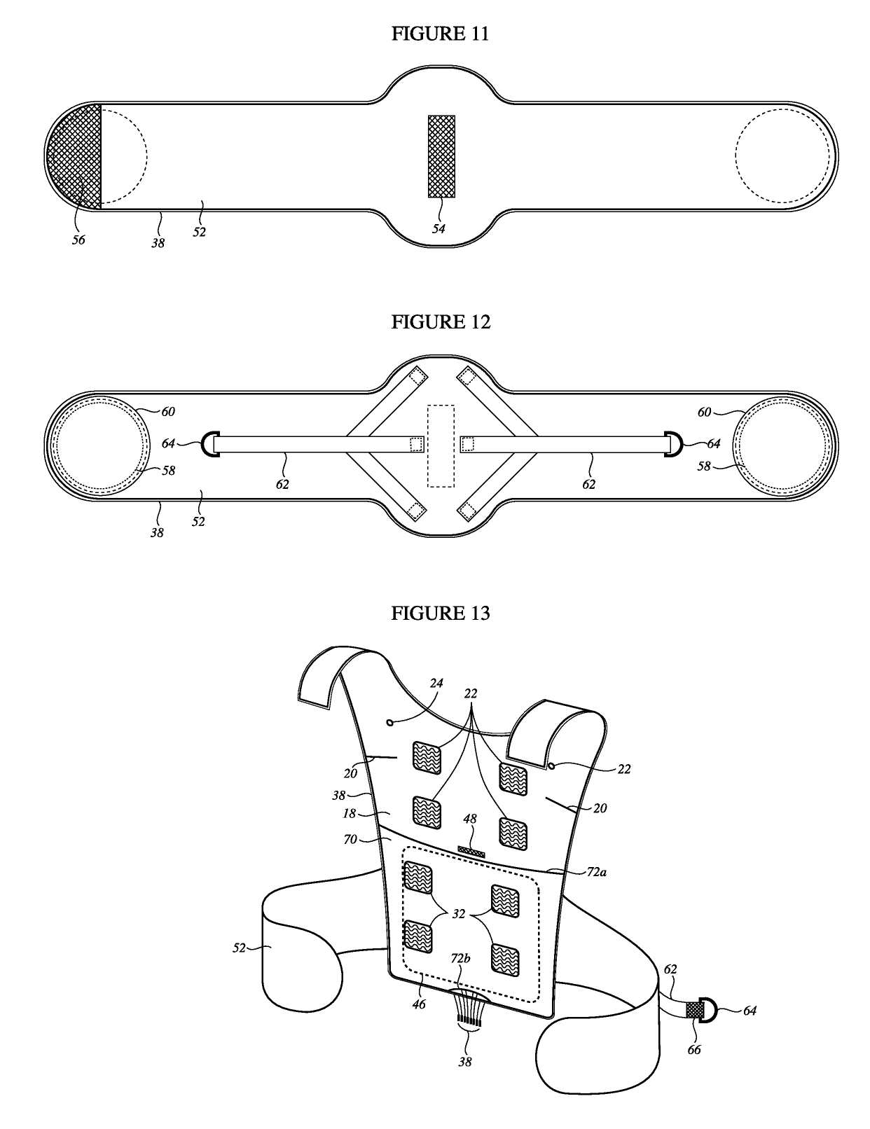

FIG. 11 illustrates that the removable belt 52 may include connecting devices 54 to attach the belt 52 to the back panel 18 and fasteners 56 to connect the belt 52 around the torso. The connecting devices 54 allow the removable belt 52 to be horizontally and vertically adjusted to an array of degrees and elevations on the back panel 18. The removable belt can be used to hold a rigid or semi-rigid insert 46 in place around the patient's back.

FIG. 12 illustrates that a rigid or semi-rigid insert 58 may be placed on the front section of the removable belt 52 to provide anterior body support. A cover 60 may be placed on top of the anterior rigid or semi-rigid insert 58. Additionally, the removable belt 52 may include the attachment of an outer belting system 62 to increase the overall compression level around the torso. The outer belting system 62 may be on the left and right sides of the removable belt 52 and may be made of an elastic material attached at or in close proximity to the center point of the removable belt 52. The outer belting system 62 can be pulled with or without the addition of a D-ring 64 at each end point, and then may be attached to the removable belt 52 using a hook fastener 66 on one side of each end. The anterior rigid or semi-rigid insert 58 could be placed around the patient's stomach or vicinity.

FIG. 13 illustrates a perspective front view of the back panel 18 according to another exemplary embodiment of the present invention showing the back panel with a compartment 70. The compartment 70 may be made of foam laminated with fabric that has loop properties enabling the attachment of removable medical electrodes 22 featuring gel or hook fasteners, with the compartment's 70 interior accessible through an upper opening 72A. The compartment 70 may also include a lower opening 72B to feed through lead wires from medical electrodes 22 that are attached to the compartment 70. In one embodiment, the compartment 70 may include multiple openings 72A along one or more of its edges. Alternatively, two or more separate compartments 70 with one or more openings 72A along one or more of its edges may be included on the back panel 18 to store a plurality of accessories, such as rigid or semi-rigid inserts 46, hot/cold packs. FIG. 13 is an alternative approach to having a removable panel, as found in FIGS. 9 and 10, and shows a large compartment 70 built into the back panel 18 where the rigid or semi-rigid insert 46 can be positioned. The rigid or semi-rigid insert 46 (shown as the dotted line) is slid into the slot which is then closed. The line going across the vest from the left middle to the right middle is the upper opening 72A of the compartment 70, and the fastener 48 is what sticks to the upper opening 72A to prevent the rigid or semi-rigid insert 46 from sliding up and out of the compartment 70.

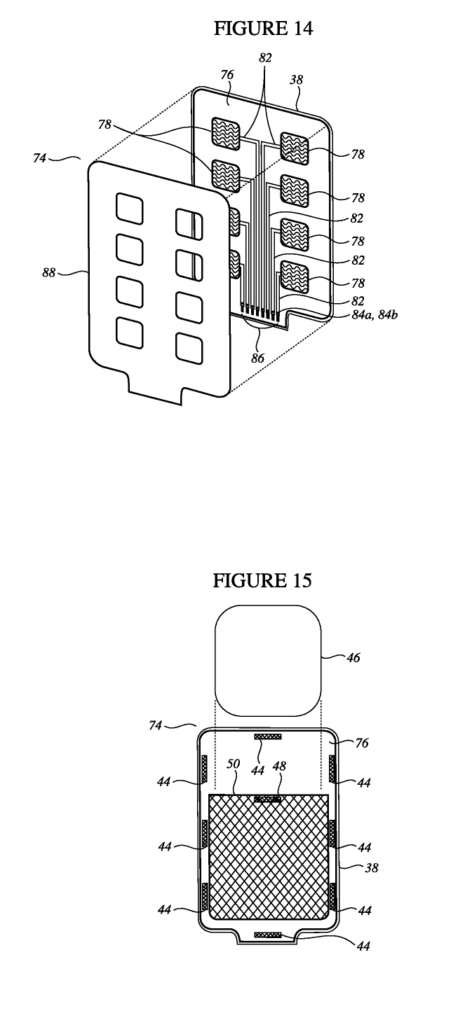

FIG. 14 illustrates an embodiment of the present invention on which the conductive garment includes a removable electrode panel 74 with embedded electrode circuits 82. This assembly fits inside the back panel 18. Fixed electrodes 78 are sewn together and created as one assembly, thus individual electrodes 78 typically are not removable from this panel 74 as opposed to FIG. 9 in which the electrodes 22 can be removed. In the embodiment illustrated in FIG. 14, the electrodes 78 may be placed on the side contacting the patient's skin, while the opposite side may include a compartment 50 to store accessories, such as a rigid or semi-rigid insert 46, hot/cold packs, that affixes to the vest's posterior panel 18. The bottom edge may have an opening to access lead wire adapters 86 and attach or detach lead wires. The shape of the removable panel 74 may be rectilinear, curvilinear, or a combination thereof. The removable panel 74 may be made in different sizes by varying the overall length and width. Alternatively, two or more separate compartments 50 may be included on the rear side of a single removable panel 74 to store a plurality of accessories, such as rigid or semi-rigid inserts 46, hot/cold packs, and the like.

FIG. 15 is similar to FIG. 10, but FIG. 10 shows lead wires coming down further. In the compartment 50, besides the rigid or semi-rigid insert 46 the patient can insert a hot/cold pack.

A removable panel 74 may serve as a base to attach electrode 78, which can be made from flexible material, such as conductive fabric, and an electrical circuit trace 82. Metal prong fastener 84a may be coated with paint or covered by plastic on the exposed side and connects to a metal stud fastener 84b on the blind side. A snap-on lead wire adapter 86 may attach to a metal stud fastener 84b to allow continuity of the electrical circuit from medical lead wire to electrode 78. Alternatively, a lead wire socket (not shown) and electrode 78 may be attached to opposite ends of a trace printed on a flexible substrate using a conductive bonding agent, such as an electrically conductive adhesive, and/or solder, to allow continuity of the electrical circuit from medical lead wire to electrode 78. Cover 88 may protect the outer edges of the electrodes 78 and electrical circuit traces 82.

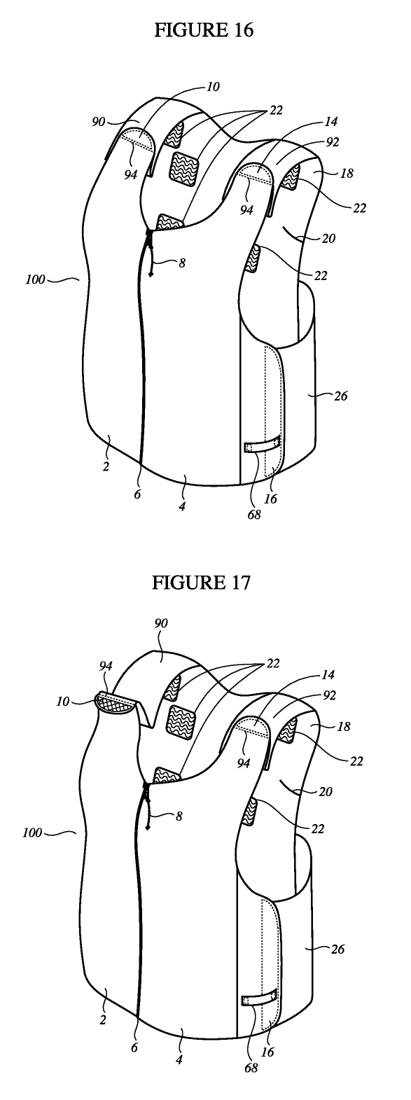

FIGS. 16 and 17 illustrates an alternative embodiment of the present invention on which the conductive garment includes semi-detachable shoulder straps to allow the patient to adjust the conductive garment's length for a snug fit against the skin. A semi-detachable shoulder strap may be made by joining the posterior shoulder straps 90 and 92 to the first front panel 2 and the second front panel 4 shoulder straps respectively, to form a shoulder junction 94 comprised of two adjacent margins or by offsetting one or both margins. In addition, connection points 10 and 14 may be attached to each shoulder junction 94 area and pulled towards the posterior side of the garment for attachment to the back panel 18. In one embodiment, the connecting points 10 and 14 may be a hook type material. Residual material from the back panel 18 around the shoulder junction 94 area may be folded on top of itself and layered below the first front panel 2 and the second front panel 4. This residual material from the back panel 18 may be fastened to the first front panel 2 and the second front panel 4 using interconnecting devices, such as hook and loop fasteners, adhesive strips, clips, buttons, pins, snaps, or clasps. As illustrated in FIG. 17, shoulder straps 90, 92 are actually sewn to shoulder junction 94, but an adjustment is still possible because there is hook fastener 10, 14 at end of the shoulder junction 94, which is shown as a broken line on the second front panel 4. The height of the conductive garment is adjusted by peeling off the hook fastener on shoulder straps 90 or 92 and re-attaching it to shoulder strap 90 or 92 in an appropriate position to maintain the proper fit. All hook fasteners herein (and any other things that connect or attach) can be made from VELCRO or any other connection mechanism which attaches to a cooperating surface which bonds together.

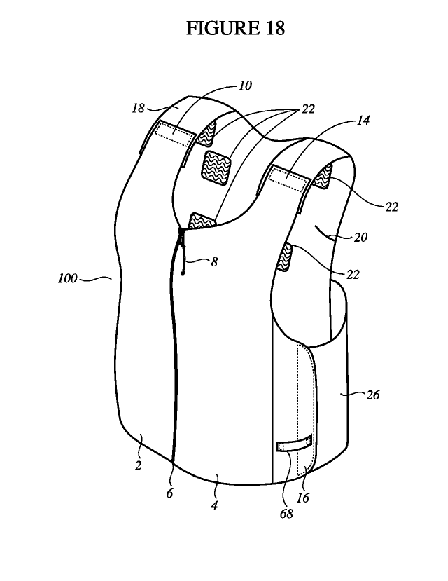

FIG. 18 is similar to FIG. 1, but connecting points 10, 14 are squared off instead of round. Attached to connecting points 10, 14 is a rectangular piece of hook fastener, while in FIG. 1 the same piece of hook fastener is curved. Horizontal belt loop 68 can be used to attach and detach a stimulation device (not shown). The connecting points 10, 14 (which can be VELCRO, etc.) are embedded into the front panels 2, 4 and are shown in broken lines (as in the other drawings as well) because they are not visible from this view since they are located on the other side from the side that is visible in the drawing. The connecting points 10, 14 can affix onto the surface of back panel 10 (which is a surface that removably affixes to the connecting points 10, 14) to removably attach the front panels 2, 4 to the back panel 10.

The removable compartment 50, the posterior rigid or semi-rigid insert 46, and the removable belt 52 with anterior rigid or semi-rigid inserts 58 may allow the conductive garment to serve as both a conductive garment and lumbosacral orthotic brace. This added functionality provides greater marketability.

The electrodes in the garment can be electrically attached to an electrical connector which can then be plugged (using a longer cord/cable if necessary) to electronic medical equipment (e.g., stimulator, electrocardiograph, EKG machine, heart rate monitor, or any electrical equipment that can send or receive signals to electrodes).

All parts herein that connect/attach to other parts can be attached using any suitable attachment mechanism (e.g., hook fastener (e.g., VELCRO) attaches to a surface with compatible loop fastener properties). For example, elements (including but not limited to these) 10, 12, 14, 16, 28, 30, 34, 44, 48, 54, 56, 94 can be made of hook fastener and the surface they attach to is any surface that attaches to a hook fastener.

It should be understood, of course, that the foregoing relates to exemplary embodiments of the invention and that modifications may be made without departing from the spirit and scope of the invention as set forth in the following claims.

What is claimed is:

1. A conductive garment comprising:
a first front panel;
a second front panel detachably connected to the first front panel by an interconnecting device;
a back panel;
a first lateral panel and a second lateral panel, each lateral panel including a first end and second end;
wherein the first lateral panel and the second lateral panel are placed on opposite sides of the back panel; and
wherein the first end of each lateral panel is detachably connected to the back panel and wherein the second end of the first lateral panel is detachably connected to the first front panel and the second end of the second lateral panel is detachably connected to the second front panel.

2. The garment as recited in claim 1, further comprising electrodes attached to the back panel.

3. The garment as recited in claim 1, further comprising an electrode panel with electrodes attached to the electrode panel.

4. The garment as recited in claim 1, further comprising a removable belt.

5. The garment as recited in claim 4, wherein the belt comprises a belting system configured to increase a compression level.

6. The garment as recited in claim 4, wherein the belt comprises a connecting device in a center of the belt, the connecting device adapted to connect to the back panel.

7. The garment as recited in claim 6, wherein the connecting device is hook fastener and the back panel is adapted to connect to hook fastener.

8. The garment as recited in claim 1, further comprising a removable panel that attaches to the back panel.

9. The garment as recited in claim 8, further comprising an electrode panel inside the removable panel.

10. The garment as recited in claim 8, further comprising a hot/cold pack in the removable panel.

11. The garment as recited in claim 1, further comprising a pouch in the back panel.

12. The garment as recited in claim 11, further comprising a rigid or semi-rigid insert inside the pouch.

13. The garment as recited in claim 1, wherein the back panel comprises a first shoulder strap and a second shoulder strap.

14. The garment as recited in claim 13, wherein the first front panel comprises a first connecting point and the second front panel comprises a second connecting point, and the first connecting point is configured to attach to the first shoulder strap and the second connecting point is configured to attach to the second shoulder strap.

15. The garment as recited in claim 14, wherein the first shoulder strap is completely detachable from the first front panel and the second shoulder strap is completely detachable from the second front panel.

16. The garment as recited in claim 14, wherein the first shoulder strap is physically attached to a portion of the first front panel near the first connecting point, and the second shoulder strap is physically attached to a portion of the second front panel near the second connecting point.

17. The garment as recited in claim 1, further comprising a first extension panel placed between the first front panel and the first lateral panel, and a second extension panel placed between the second front panel and the second lateral panel.

18. A method for using electrodes in medical applications, the method comprising:
providing a garment comprising:
a first front panel;
a second front panel detachably connected to the first front panel by an interconnecting device;
a back panel;
a first lateral panel and a second lateral panel, each lateral panel including a first end and second end;
an electrical connector connected to electrodes in the garment;
wherein the first lateral panel and the second lateral panel are placed on opposite sides of the back panel;
wherein the first end of each lateral panel is detachably connected to the back panel and wherein the second end of the first lateral panel is detachably connected to the first front panel and the second end of the second lateral panel is detachably connected to the second front panel; and
connecting the electrical connector to electronic medical equipment.

19. The method as recited in claim 18, wherein the garment further comprises electrodes attached to the back panel.

20. The method as recited in claim 18, wherein the garment further comprises an electrode panel with electrodes attached to the electrode panel.
